(19) United States
(12) Patent Application Publication
(10) Pub. No.: US 2007/0281282 A1
(43) Pub. Date: Dec. 6, 2007

(54) Adjustable System For Bonded Composite Dentistry

(76) Inventor: Frank E. Delmonico, Wakefield, RI (US)

Correspondence Address: MICHAEL BEST & FRIEDRICH LLP, 100 E WISCONSIN AVENUE, Suite 3300, MILWAUKEE, WI, 53202, US

(21) Appl. No.: 10/582,038

(22) PCT Filed: Dec. 15, 2004
(86) PCT No.: PCT/US04/41981

§ 371 Date: Apr. 11, 2007

Related U.S. Application Data
(60) Provisional application No. 60/529,475, filed on Dec. 15, 2003.

(51) Int. Cl. A61C 13/225

(52) U.S. Cl. 433/180

(57) ABSTRACT

A dental bridge and a method of assembling a dental bridge. An adjustable system for bonded composites may generally include a ladder supporting a truss in one of multiple relative positions therewith. The ladder generally includes opposing rails connected by a plurality of rungs. The plurality of rungs are spaced along the rails to define a plurality of openings between adjacent rungs. The truss generally includes a metal strip having a plurality of upstanding projections. The projections are correspondingly spaced with the openings defined in the ladder to allow the truss to engage the ladder in a plurality of relative configurations. The combination of the ladder and truss may also provides a torsionally rigid and substantially stiff assembly with which to support one or more pontics and/or unstable teeth.

### RELATED APPLICATION

The present application claims the benefit of prior filed, co-pending provisional patent Application Ser. No. 60/529,475, filed Dec. 15, 2003. The present application incorporates by reference Application Ser. No. 60/529,475, and the entire disclosure of that application is considered as being part of the present application.

### FIELD OF THE INVENTION

This invention relates generally to a dental bridge and, more particularly, to bridge framework for use in producing tooth-replacement bridges or splinting unstable teeth.

### SUMMARY OF THE INVENTION

In some aspects and in some constructions, an adjustable system for bonded composites may generally include a ladder supporting a truss in one of multiple relative positions therewith. The ladder generally includes opposing rails connected by a plurality of rungs. The plurality of rungs are spaced along the rails to define a plurality of openings between adjacent rungs. The truss generally includes a metal strip having a plurality of upstanding projections. The projections are correspondingly spaced with the openings defined in the ladder to allow the truss to engage the ladder in a plurality of relative configurations. The combination of the ladder and truss may also provides a torsionally rigid and substantially stiff assembly with which to support one or more pontics and/or unstable teeth.

In some aspects and in some constructions, a system for bonded composites may generally include a reinforced substructure for supporting a pontic. The reinforced metal substructure may be substantially webbed, or generally includes a plurality of apertures or perforations therethrough to allow the flow or seepage of resin through and around the metal substructure for increased bonding strength of the resin between the pontic and the metal substructure. The substructure also generally includes reinforcing structure or framework in a direction along the ladder and truss, to which the metal substructure is coupled, and in a direction substantially normal to the ladder and truss.

In some aspects and in some constructions, a system for bonded composites may generally include the ladder and truss structure having a sufficient length to extend substantially through one or more teeth and a plurality of apertures or perforations therein to allow the flow or seepage of resin through and around the ladder and truss for increased bonding strength of the resin between the supporting one or more teeth and the ladder and truss.

In some aspects and in some constructions, a system for bonded composites may generally include provisions for occlusal stops. One or more projections on the truss may be configured to extend sufficiently far through the ladder such that the one or more projections serve to slow or halt the occlusal wear of the pontic.

In some aspects and in some constructions, a system for bonded composites may generally include a bendable ladder structure configured to go through a quadrant of teeth, a half-arch of teeth, or a full arch of teeth. The ladder structure may also be configured with an anterior segment for full or partial arch splinting. The anterior segment may include a single rail connecting ladder structures at opposite ends thereof, in addition to a plurality of apertures or perforations therethrough to allow the flow or seepage of resin through and around the ladder and truss for increased bonding strength of the resin between the supporting one or more teeth and the anterior segment. In addition, the bendable ladder structure may support a relatively long span of teeth or other attachments (e.g., arch wires).

In some aspects and in some constructions, a system for bonded composites may generally include a ladder and truss structure adaptable by the dentist and/or oral surgeon while sitting chair side with their patients. The adjustability built into the ladder and truss structure allows the dentist and/or oral surgeon to make adjustments to the composite without having to send it off-site to a laboratory.

Independent features and independent advantages of the present invention will become apparent to those skilled in the art upon review of the following detailed description, claims and drawings.

### BRIEF DESCRIPTION OF THE DRAWINGS

FIG. 1 is a perspective view of a ladder structure.

FIG. 2 is a perspective view of a truss structure that is engageable with the ladder structure shown in FIG. 1.

FIG. 3 is a perspective view of the truss structure shown in FIG. 2 with a reinforcing structure for supporting a pontic.

FIG. 4 is an exploded view of the ladder structure shown in FIG. 1 and the truss structure shown in FIG. 2 and the reinforcing structure shown in FIG. 3.

FIG. 5 is a top perspective view of the ladder structure shown in FIG. 1, and the truss structure shown in FIG. 2, connected to form a bridge, with the reinforcing structure shown in FIG. 3 coupled to the bridge for supporting a pontic in preparation for bonding to prepared teeth.

FIG. 6 is a perspective view of an anterior perforated segment.

FIG. 7 is a perspective view of the ladder structure shown in FIG. 1 connected to the anterior perforated segment shown in FIG. 6.

FIG. 8 is a perspective view of two ladder structures shown in FIG. 1 connected to the anterior perforated segment shown in FIG. 6.

FIG. 9 is a perspective view of a combination of the bridge and reinforcing structure shown in FIG. 5, coupled to the anterior perforated segment shown in FIG. 6.

FIG. 10 is a rear perspective view of a metal shield for supporting an anterior pontic.

FIG. 11 is another perspective view of the metal shield in FIG. 10 for supporting an anterior pontic.

FIG. 12 is a perspective view of the bridge and reinforcing structure of FIG. 5 for supporting a pontic connected to the anterior perforated segment of FIG. 6 with the metal shield of FIG. 10 connected to the anterior perforated segment for supporting an anterior pontic.

FIG. 13 is a perspective view of an anterior arch wire.

FIG. 13a is an enlarged perspective view illustrating the connection between the anterior arch wire shown in FIG. 13 and the ladder structure shown in FIG. 1.

FIG. 13b is a perspective view of the combination of the anterior arch wire shown in FIG. 13 connected to the bridge and reinforcing structure shown in FIG. 5.

FIG. 14 is a perspective view of two reinforcing structures supported by the bridge shown in FIG. 5.

FIG. 14a is an exploded view of the assembly shown in FIG. 14.

FIG. 14b is a perspective view of the assembly of FIG. 14 attached to two surrounding teeth.

FIG. 15 is a perspective view of another construction of the bridge shown in FIG. 5 with one reinforcing structure for supporting a pontic with the bridge inserted into an adjacent tooth and an internal view of the bridge inserted into a tooth on the right.

FIG. 15a is a perspective view of the assembly shown in FIG. 15 with the an external view of the bridge inserted into the tooth on the right.

FIG. 15b is a perspective view of the assembly shown in FIG. 15 with the middle and right teeth filled with composite resin to enclose the bridge.

FIG. 16 is a perspective view of an assembled bridge and reinforcing structure shown in FIG. 5 during the process of inserting a pontic onto the reinforcing structure.

FIG. 16a is a perspective view of the assembly shown in FIG. 16 with the pontic completely inserted onto the reinforcing structure.

FIG. 17 is a perspective view of another arrangement of a bridge and reinforcing structure inserted in an edentulous space between two teeth with the tooth on the left filled with composite resin.

FIG. 17a is a perspective view of another arrangement of a bridge with two reinforcing structures adjacent to one another, the middle reinforcing structure coupled to a pontic partially filled with composite resin and adjacent to a tooth.

FIG. 18 is a perspective view of a temporary or permanent bridge abutment lingual finger metal reinforcement.

FIG. 19 is a perspective view of multiple permanent bridge abutment lingual finger metal reinforcements adjacent to a reinforcing structure coupled to the bridge as shown in FIG. 5.

FIG. 20 is a perspective view of a cast bridge with a reinforcing structure as shown in FIG. 5.

FIG. 20a is an exploded view of the assembly shown in FIG. 20.

FIG. 20b is an exploded view of another construction of the reinforcing structure, with a metal substructure coupled to a cast bridge.

FIG. 20c is an assembled view of the construction shown in FIG. 20b before the bridge has been cast.

FIG. 20d is an assembled view of the construction shown in FIG. 20b of the cast bridge and reinforcing structure.

FIG. 21 is a perspective view of a truss for an insert for use in individual single composite restorations.

FIG. 22 is a perspective view of the truss shown in FIG. 21 connected to a ladder to form a bridge for an insert for use in individual single composite restorations.

FIG. 23 is a side view of the combination shown in FIG. 22 inserted into a single tooth.

FIG. 24 is a perspective view of the combination shown in FIG. 22 inserted into a single tooth.

FIG. 25 is a perspective view of another construction of an insert for use in individual single composite restorations, with a cast bridge.

FIGS. 25a-25c are views of the insert shown in FIG. 25 for use in individual single composite restorations.

FIG. 26 is a perspective view of the insert shown in FIG. 25 inserted into a tooth that is ready for the addition of composite resin for bonding to the tooth.

FIG. 26a is a perspective view of the insert shown in FIG. 25 with composite resin bonding a quarter of a pontic to the insert.

FIG. 26b is a perspective view of the insert bonded to a quarter of a pontic shown in FIG. 26a being inserted into a damaged tooth for bonding thereto.

FIG. 26c is a perspective view of the insert bonded to a quarter of a pontic shown in FIG. 26a inserted into a damaged for bonding thereto.

FIG. 27 is a perspective view of a bridge and reinforcing structure of FIG. 5 with connections for fitting into the jaw.

FIG. 28 is an exploded view of the assembly of FIG. 27.

FIGS. 29 and 29a are views of a bridge with a reinforcing structure of FIG. 5 inserted into the lower set of teeth, with the reinforcing structure fitting into an edentulous space.

Before any features and at least one construction of the invention are explained in detail, it is to be understood that the invention is not limited in its application to the details of construction and the arrangements of the components set forth in the following description or illustrated in the drawings. The invention is capable of other constructions and of being practiced or being carried out in various ways. Also, it is understood that the phraseology and terminology used herein is for the purpose of description and should not be regarded as limiting. The use of “including”, “having” and “comprising” and variations thereof herein is meant to encompass the items listed thereafter and equivalents thereof as well as additional items.

Although references may be made below to directions, such as upper, lower, downward, upward, rearward, bottom, front, rear, etc., in describing the drawings, these references are made relative to the drawings (as normally viewed) for convenience. These directions are not intended to be taken literally or limit the present invention in any form. In addition, terms such as “first” and “second” are used herein for purposes of description and are not intended to indicate or imply relative importance or significance.

### DETAILED DESCRIPTION

In some aspects and in some constructions, the present invention may generally provide an adjustable system for bonded composite dentistry. The system for bonded composites generally includes multiple parts that can be altered and used alone or in combination to perform a plurality of operations such as, for example, splinting unstable teeth, supporting pontics, bridging gaps between teeth, preventing additional wear on new or existing teeth, etc.

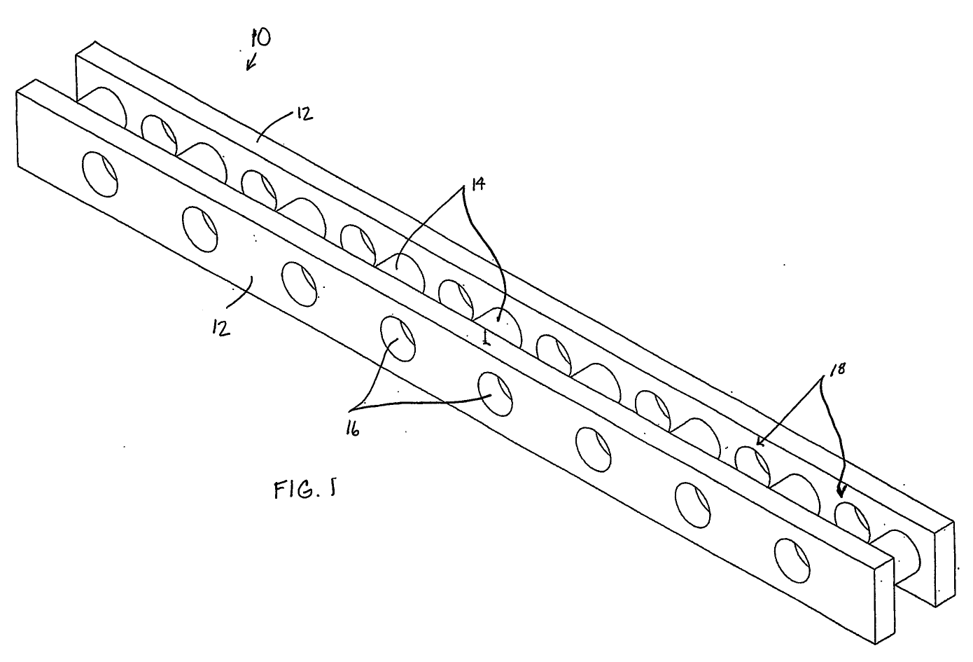

As shown in FIG. 1, a first member, a ladder structure, or a ladder 10, includes opposing rails 12 connected by a plurality of rungs 14. The length of the ladder 10 can be adjusted and may vary greatly. In the illustrated construction and in some aspects, the configuration of the ladder 10 provides the ladder 10 with an increased torsional rigidity and stiffness not found in conventional bridge framework and/or connecting assemblies.

In the illustrated construction, the rails 12 each include a plurality of apertures or perforations 16 therethrough. The apertures 16 can be round and are distributed along the ladder 10 to, for example, allow for the flow of composite resin. In the illustrated construction, the rails 12 are configured such that they are separable from one another so a segment comprising a singular rail may be formed, if desired, as part of the overall framework of the ladder 10.

The plurality of rungs 14 are spaced along the rails 12 to define a plurality of openings 18 between adjacent rungs 14. The rungs 14 may be hollow or solid. The rungs 14 may have various cross-sectional shapes such as, for example, round, oval or square.

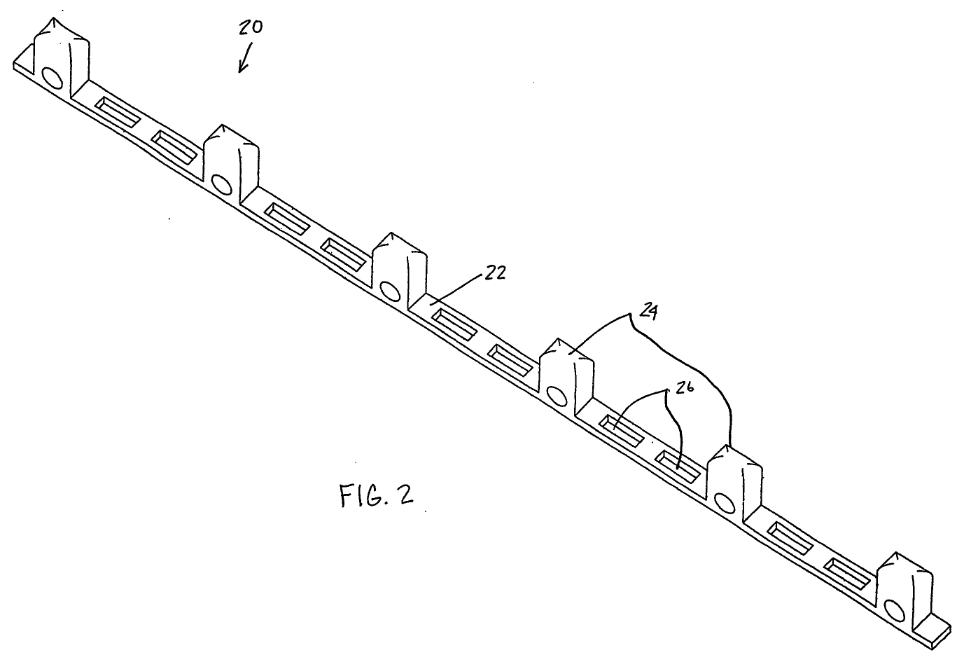

With reference to FIG. 2, a second member, a truss structure, or a truss 20, is shown. In the illustrated construction and in some aspects, the combination of the ladder 10 and truss 20 also provides a torsionally rigid and substantially stiff bridge with which to support one or more pontics and/or unstable teeth.

In the illustrated construction, the truss 20 includes a strip 22 having a plurality of upstanding projections 24. The projections 24 may act as occlusal stops and to protect the biting portion of bonded teeth from the wear that occurs through mastication and contact with the opposite set of teeth. The projections 24 of the truss 20 are correspondingly spaced with the openings 18 defined in the ladder 10 to allow the truss 20 to engage the ladder 10 in a plurality of relative configurations to yield abridge. One or more apertures 26 may also be formed through the truss 20 in a location between the projections 24.

The projections 24 may be arranged on the truss 20 to engage in the opening 18 between every, every other, every third or every fourth rung 14 in the ladder 10. As a result, the truss 20 may fit precisely between the two rails 12, and the projections 24 may fit precisely in the opening 18 between every, every other, every third, or every fourth rung 14 in the ladder 10 to interlock the truss 20 and ladder 10. In addition, the projections 24 may act as occlusal stops by extending above the ladder 10 (e.g., ending 1-1.5 mm above the height of the top portion of the rails 12 and rungs 14). The truss 20, after interlocking with the ladder 10, reinforces and/or bridges the openings or open span between the rungs 14 on the ladder 10.

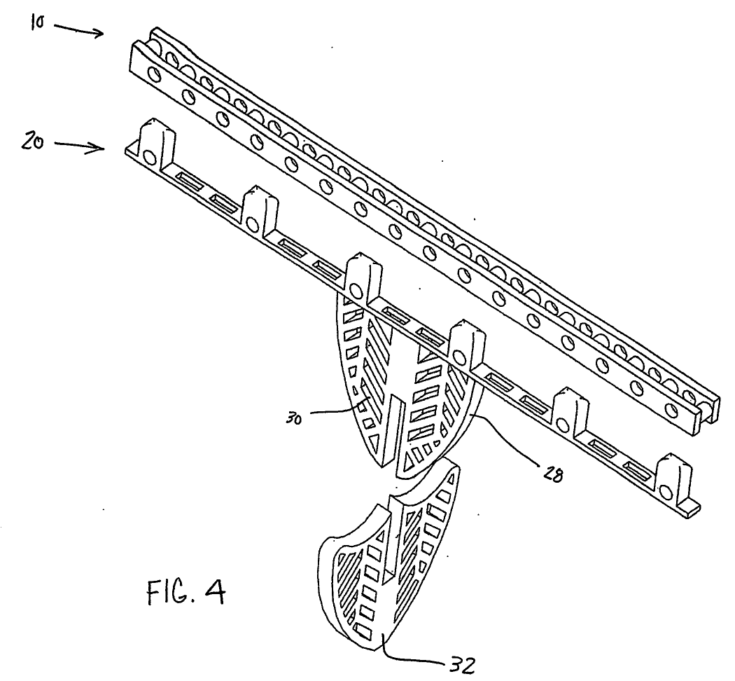

FIG. 4 shows the ladder 10, truss 20, and a reinforced substructure 28 coupled to the truss 20. In the illustrated construction, the substructure 28 is substantially webbed, and includes a plurality of apertures or perforations 30 therethrough to, for example, allow the flow or seepage of resin through and around the substructure 28 for increased bonding strength of the resin between a pontic and the substructure 28. The apertures or perforations 30 through the substructure 28 provide an increased surface area on which the resin is to bond.

The substructure 28 can be connected to a cross truss 32, as shown in FIG. 4. With the substructure 28 positioned along the truss 20, the reinforcing structure 32 can be positioned in a direction substantially normal to the truss 20, creating a reinforcing structure 34. A pontic formed around the reinforcing structure 34 may have an increased torsional rigidity as a result of the resin bonding with the reinforcing structure 34.

One or more portions of the truss 20 (e.g., the strip 22, the projections 24, the substructure 28, the cross truss 32, etc.) may be formed of metal. In the illustrated construction, the structures of the truss 20 are formed of metal. In other constructions, one or more of the structures of the truss 20 may be formed of another material.

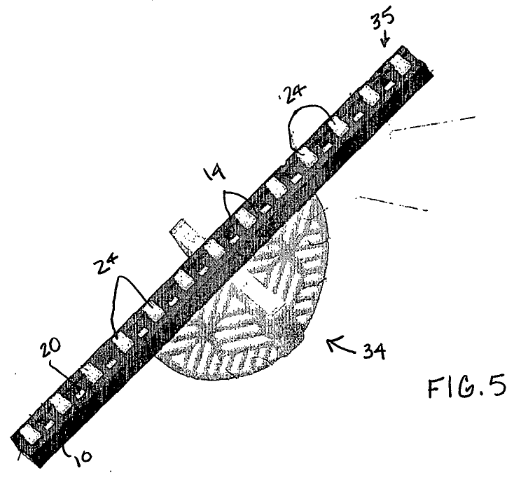

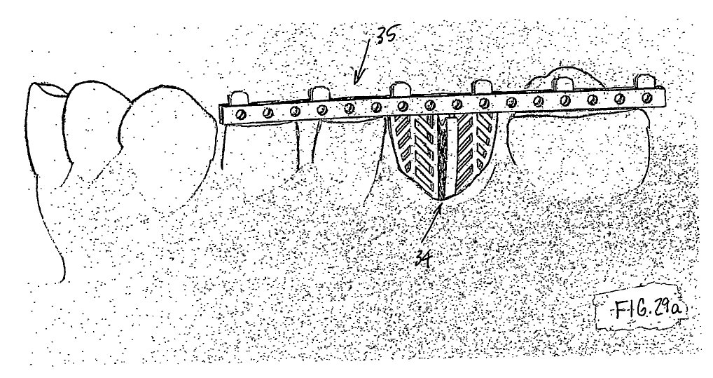

FIG. 5 shows a joined ladder 10 and truss 20, hereinafter referred to as a bridge 35. The projections 24 of the truss 20 are shown engaging every other rung 14 of the ladder 10. The rungs 14 of the ladder 10 are shown as being square in this construction. FIGS. 29 and 29a are views of a bridge 35 with a reinforcing structure 34 inserted into the lower set of teeth, with the reinforcing structure 34 fitting into an edentulous space.

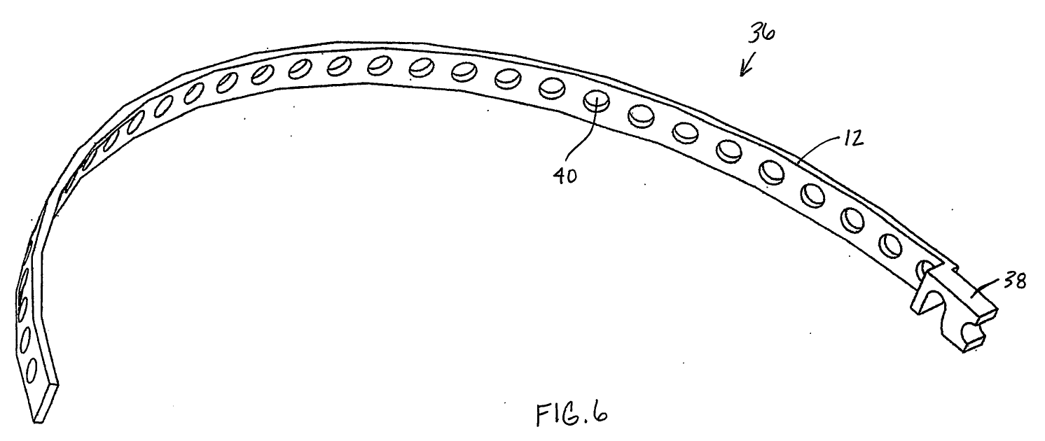

With reference to FIG. 6, an anterior perforated segment 36 is shown. The segment 36 can be formed independently or by removing the rungs 14 and one rail 12 of the ladder 10 used on the sides of the mouth. The segment 36 has a connection portion or piece 38 that can be coupled to the ladder 10 used on the side of the mouth to form a single component. The piece 38 includes a first recess or slot which extends transverse to the axis and a second recess which extends along the axis. The segment 36 includes a plurality of perforations 40 that, for example, allows resin bonding material to seep through.

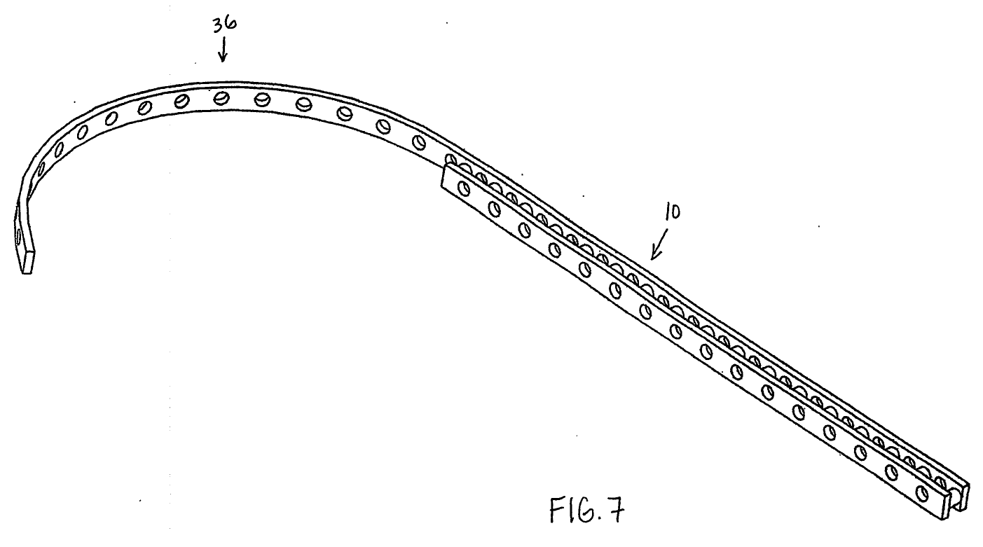

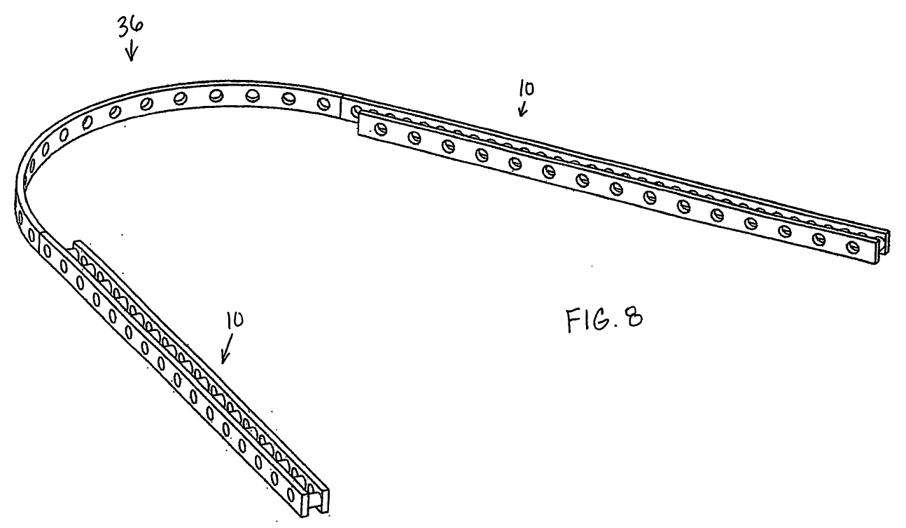

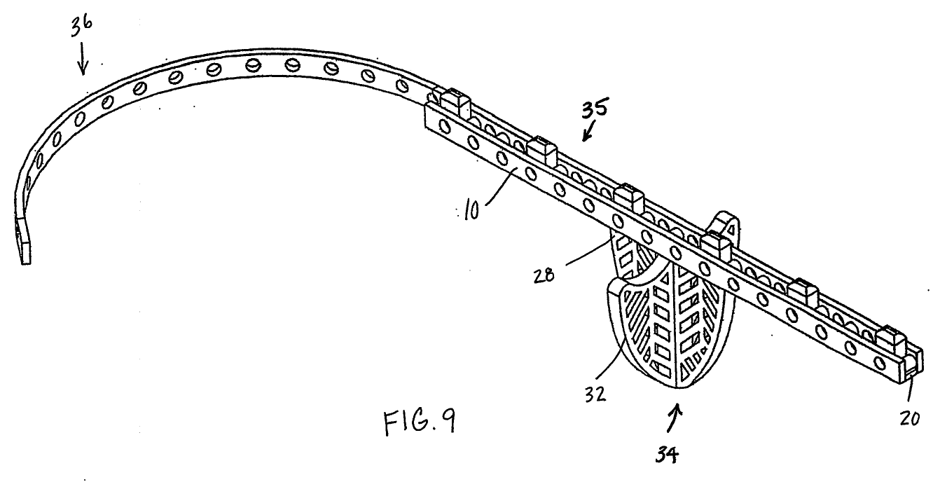

As illustrated in FIG. 7 and FIG. 8, the segment 36 can be locked to a ladder 10 on both sides. Connecting the segment 36 on both sides to two individual ladders 10 would require two connection pieces 38 rather than a single connection piece 38 as shown in FIG. 6. The segment 36, bridge 35, and reinforcing structure 34 can be used in combination for supporting a pontic and stabilizing loose teeth, as illustrated in FIG. 9.

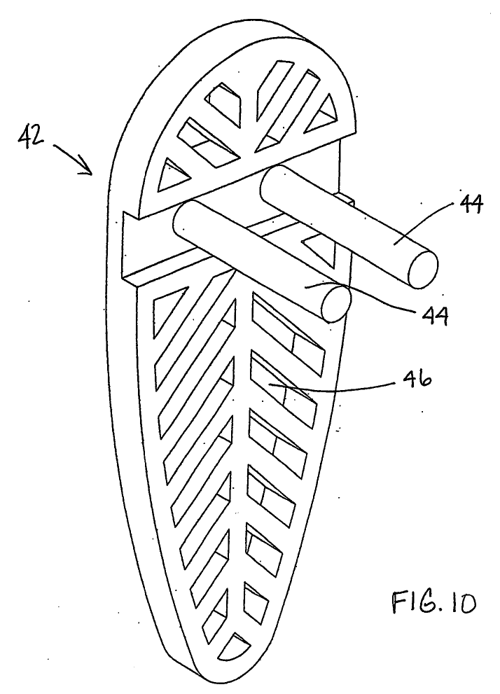

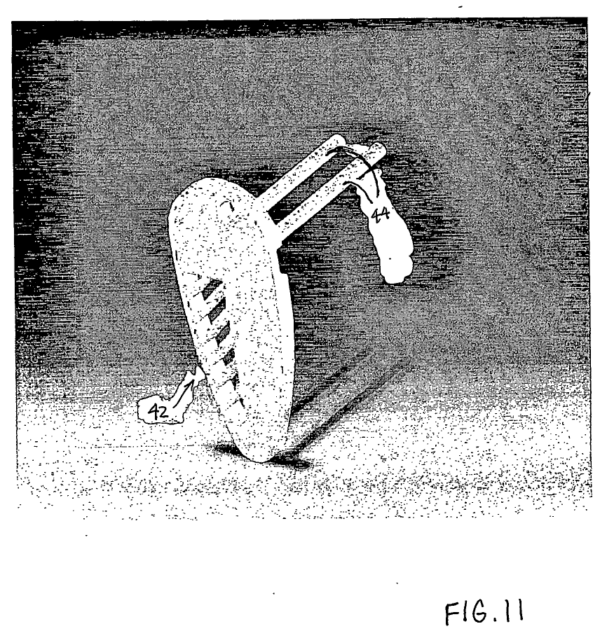

With reference to FIG. 10 and FIG. 11, alternate sides of a shield 42 are shown. The shield 42 has projections 44 positioned to engage the perforations 40 of the anterior perforated segment 36. In the illustrated construction, the shield 42 is also substantially webbed and includes a plurality of apertures or perforations 46 therethrough to, for example, allow the flow or seepage of resin through and around the segment 36 for increased bonding strength of the resin between an anterior pontic and the segment 36. In the illustrated construction, the shield 42 and the projections 44 are formed of metal but, in other constructions, may be formed of another material.

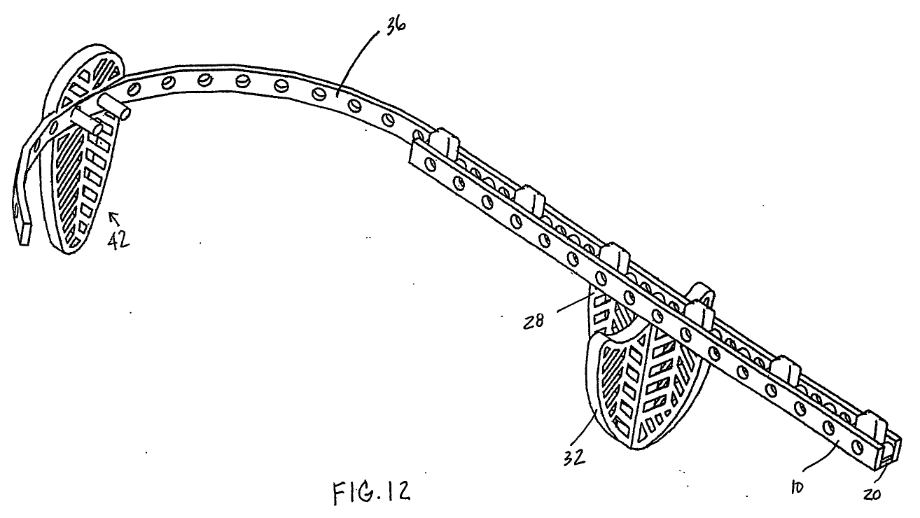

Adding a shield 42 to the combination of the segment 36, bridge 35, and reinforcing structure 34 of FIG. 9, FIG. 12 shows the framework for supporting an anterior pontic. The shield 42 is connected to the segment 36 in a manner similar to the reinforcing structure 34 being connected to the bridge 35 for supporting respective pontics. This arrangement of FIG. 12 allows for the bonding of an anterior pontic in the anterior portion of the mouth and the bonding of an additional pontic on a first side of the mouth.

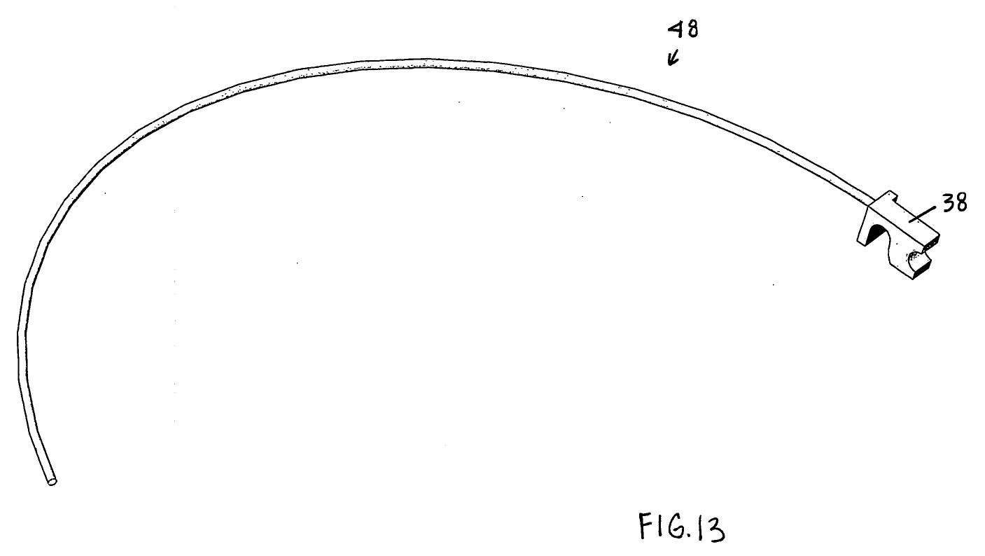

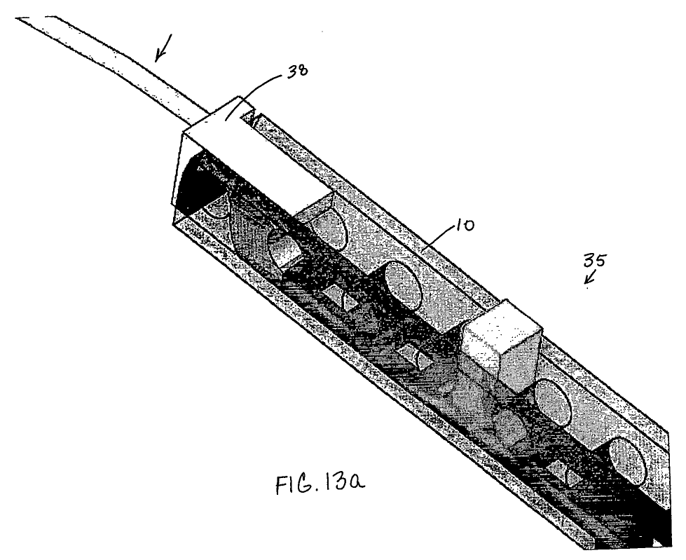

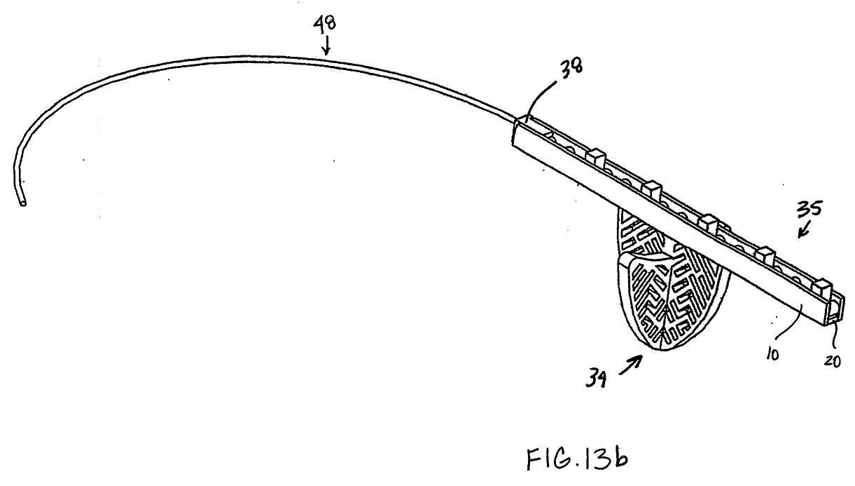

FIG. 13 shows an anterior arch wire 48 to be connected or locked into the bridge 35, and FIG. 13b shows the arch wire 48 locked into the bridge 35. The arch wire 48 is an alternate to the segment 36 for anterior support used alone or in combination with the side ladders 10. FIG. 13a shows the detail of the arch wire 48 locking into the ladder 10. The anterior arch wire 48 is connectable to the bridge 35 in the same manner as the segment 36 by using connection piece 38. The slot of the connection piece 38 receives a first rung 14 in a direction transverse to the axis, and the second recess receives a second rung 14 in a direction parallel to the axis. Also, a portion of the connection piece 38 may engage an end portion of the truss 20.

In the illustrated construction, the arch wire 48 is a solid wire as opposed to the segment 36 with perforations 40. The arch wire 48 can have a variety of applications including, for example, supporting anterior teeth that may be loose or maintaining alignment of anterior teeth. The arch wire 48 can be bonded to the back of a row of teeth, as understood in the art.

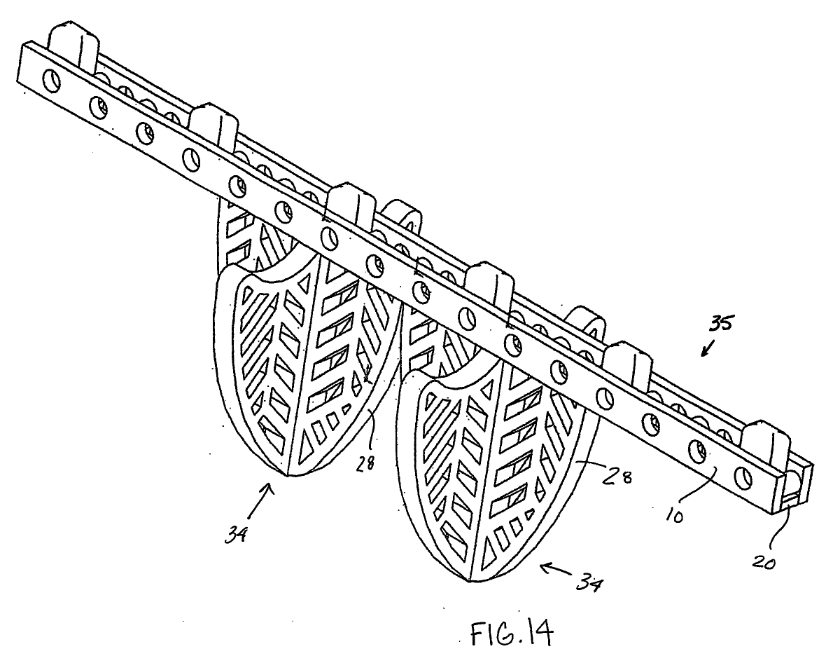

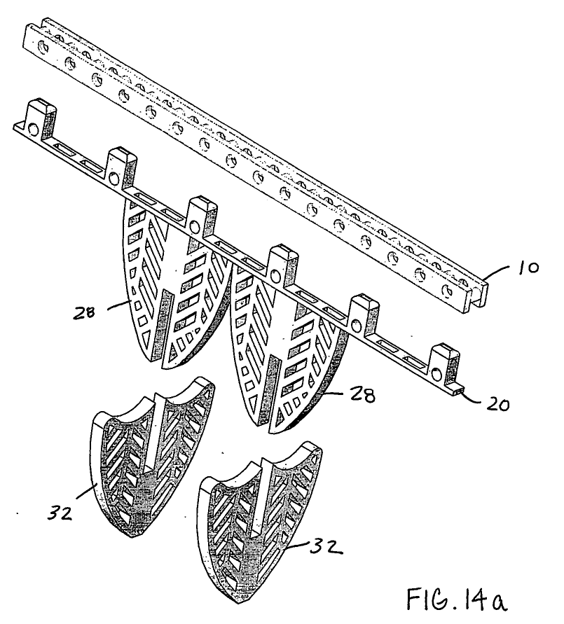

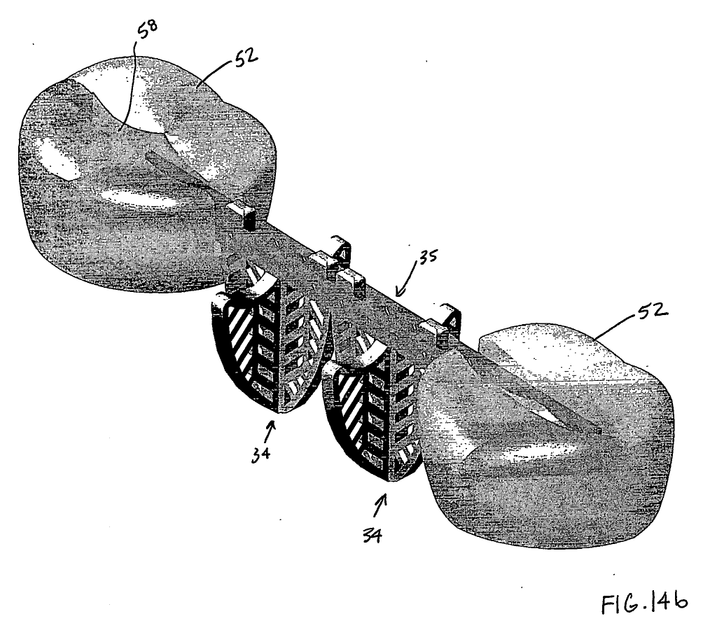

FIGS. 14, 14a and 14b show two reinforcing structures 34 supported by bridge 35. Two or more reinforcing structures 34 (arranged side by side or otherwise) may be used in this system because of the reinforcing nature of the bridge 35 provided by the truss 20 interlocking with the ladder 10. In the illustrated construction and in some aspects, this combination increases the compressive strength and resistance to torquing of the pontic provided by the metal substructure 28. The strength of the bridge 35 may also be increased by splinting as many teeth as possible to stabilize the pontic. In other words, the more abutments incorporated on either side of the reinforcing structure 34, the stronger the bridge 35.

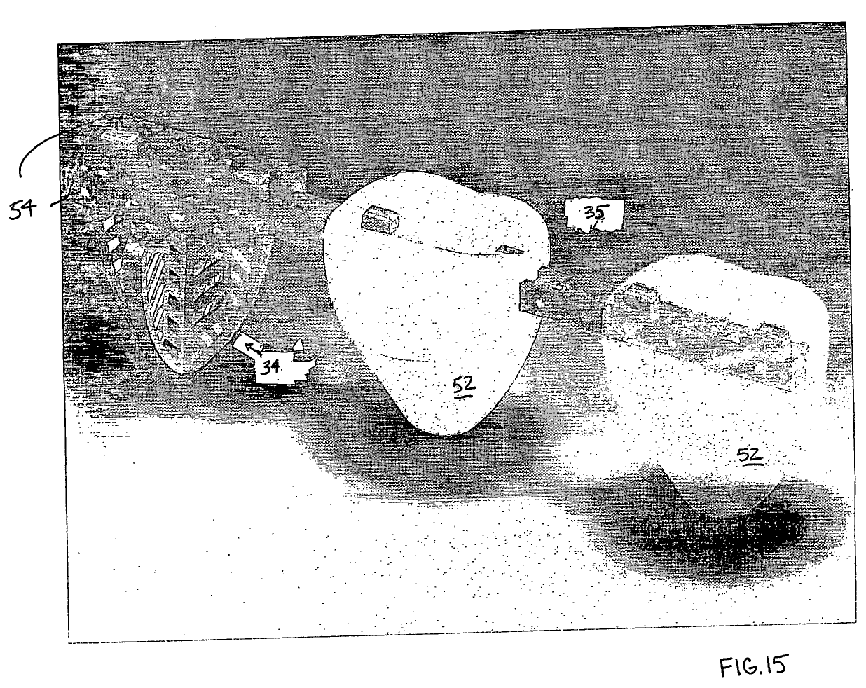

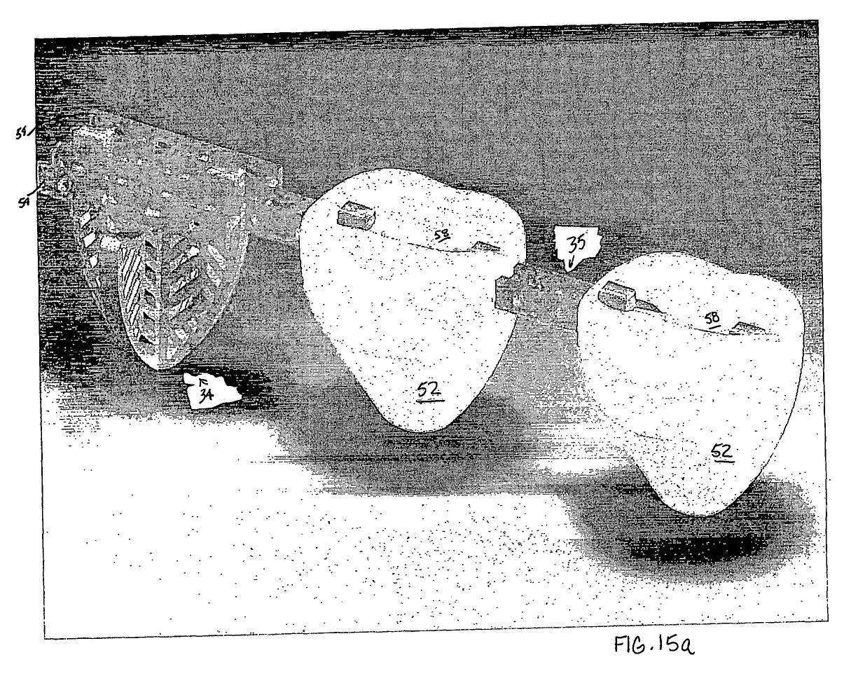

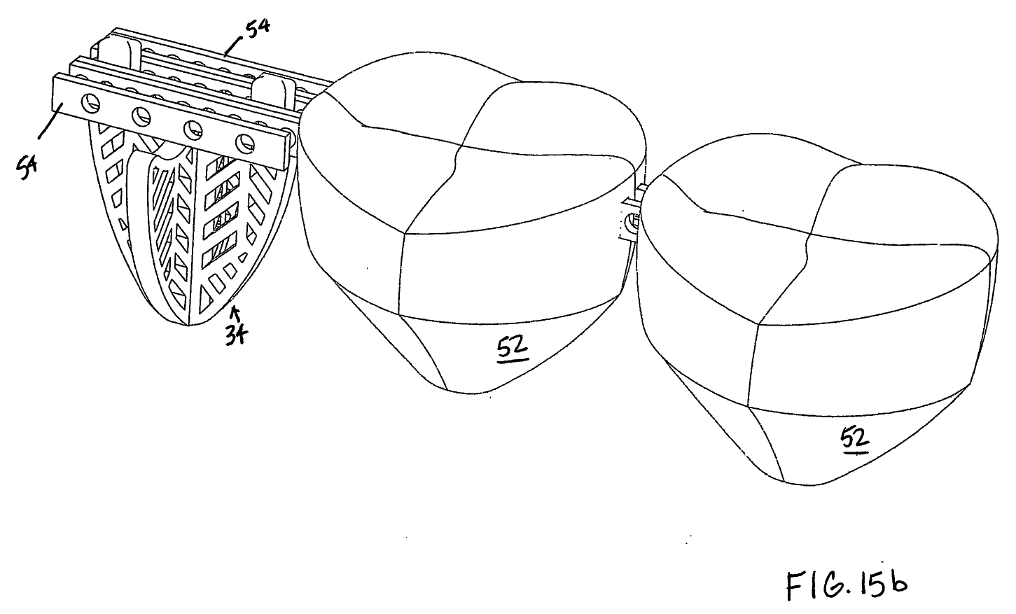

FIGS. 15, 15a and 15b illustrate the bridge 35 with one reinforcing structure 34a for supporting a pontic with the bridge 35 inserted into an adjacent tooth 52 and an internal view of the bridge 35 inserted into a tooth 52 on the right. Referring to the tooth 52 in the middle, composite resin has been partially added near the bridge 35 with a goal of bonding the bridge 35 to the middle tooth 52. This is, in effect, a prefabricated, performed composite bridge 52, which can be manufactured and supplied to dentists before a patient actually needs this bridge 35. In other words, this preformed bridge 35 could be kept in storage until the appropriate time. This preformed bridge 35 could be bonded wherever a bicuspid or molar is missing. With reference to the reinforcing structure 34 on the left side, additional ladder inserts 54 with perforations 16 are shown running parallel to the ladder 10 to provide, for example, increased bonding surface area, increased strength, etc.

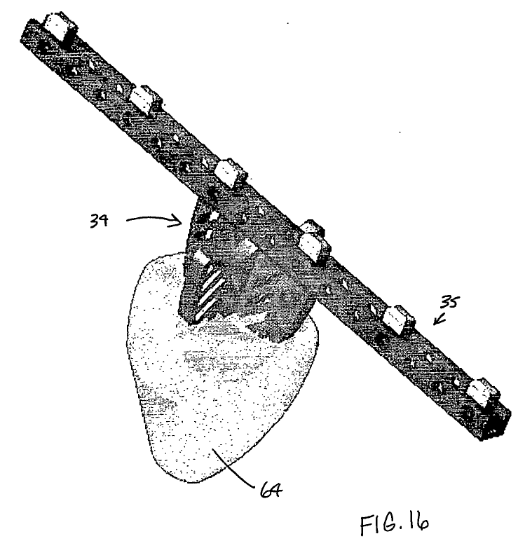

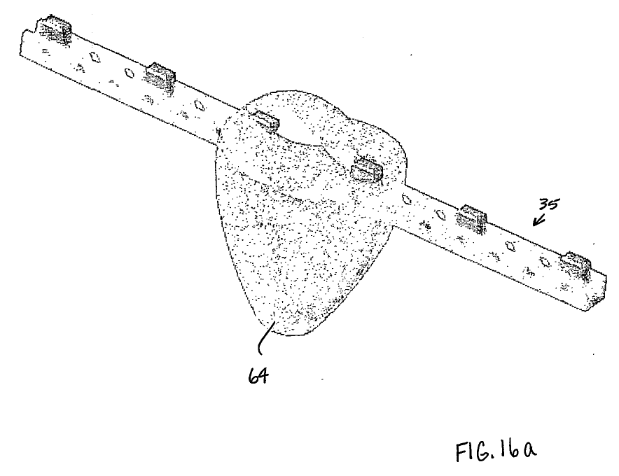

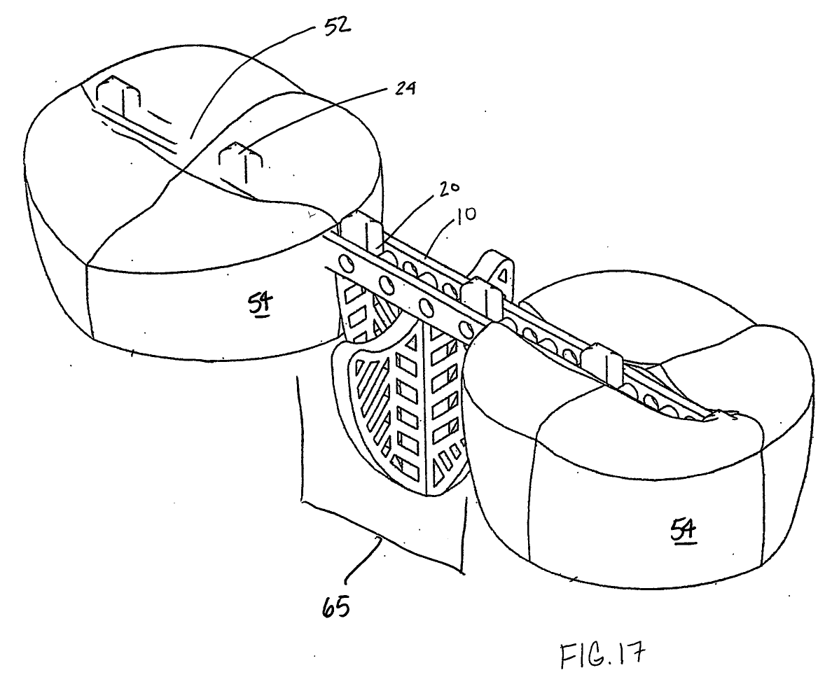

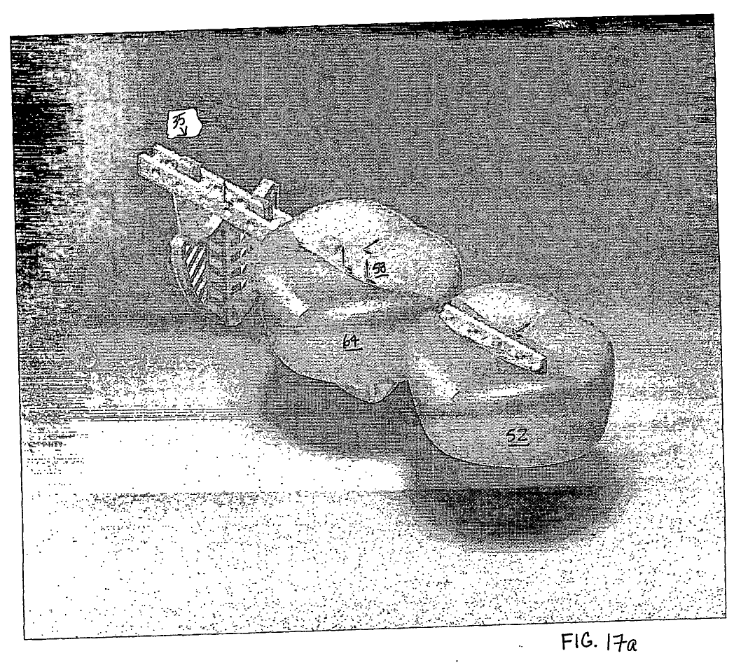

FIGS. 16 and 16a show the bridge 35 and the reinforcing structure 34 during the process of inserting a pontic 64 onto the reinforcing structure 34. Pontics 64 used with the illustrated constructions of the bridge 35 can have various sizes. The pontic 64 illustrated in FIG. 16 is of an average size. FIG. 17 shows the bridge 35 and the reinforcing structure 34 inserted in an edentulous space 65 between two teeth 52 with the tooth 52 on the left filled with composite resin 58. FIG. 17 also shows, on the tooth 52 on the left, metal projections 24 showing through the composite resin 58.

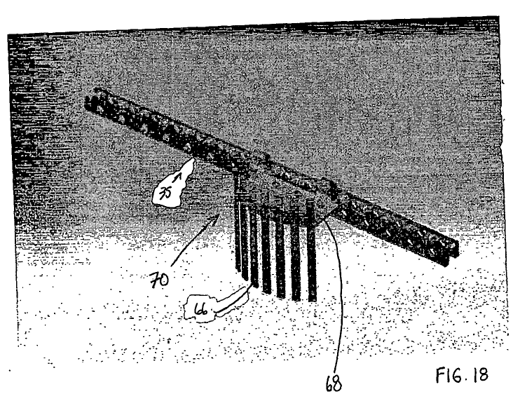

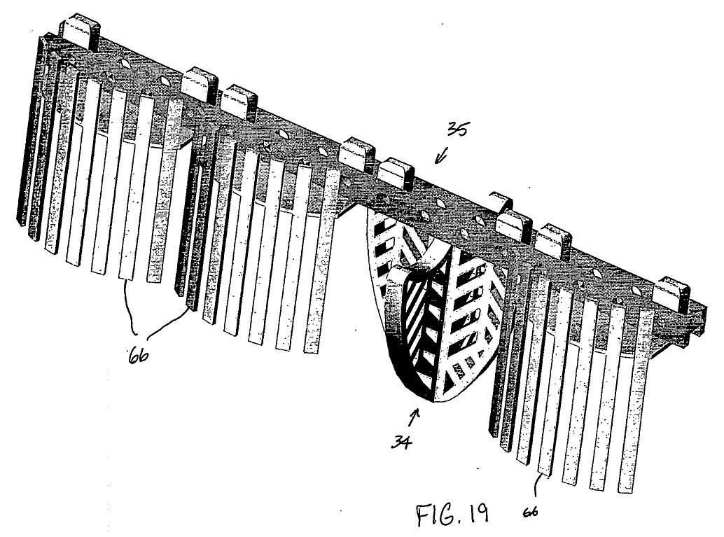

With reference to FIG. 18, lingual fingers 66, such as those illustrated, can be adapted to bridge 35. The lingual fingers 66 are attached to a plate 68 to form a lingual finger reinforcement 70, the combination adapted to be coupled to the bridge 35. As shown, the reinforcement 70 slides into the side apertures or perforations 16 in the rails 12. However, many alternate methods of attaching the reinforcements 70 to the bridge 35 are possible. The reinforcements 70 sit lingual to the prepared teeth (e.g., molar, bicuspid, cuspid, lateral, and central). FIG. 19 shows lingual fingers 66 that can be adapted around three teeth. Lingual fingers 66 can be used in a variety of situations, including but not limited to, adjacent to a reinforcing structure 34, adjacent teeth 52, adjacent to two reinforcing structures 34, etc.

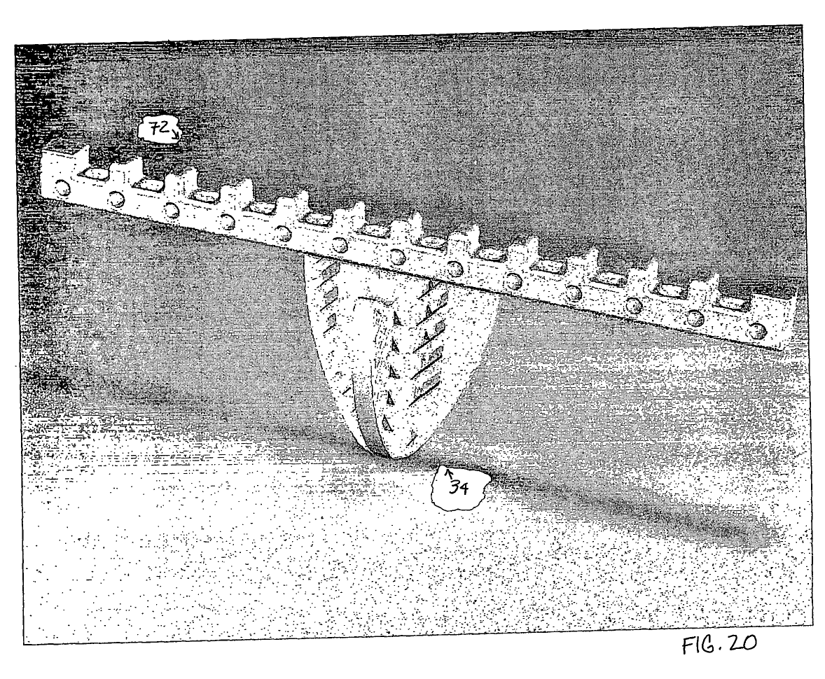

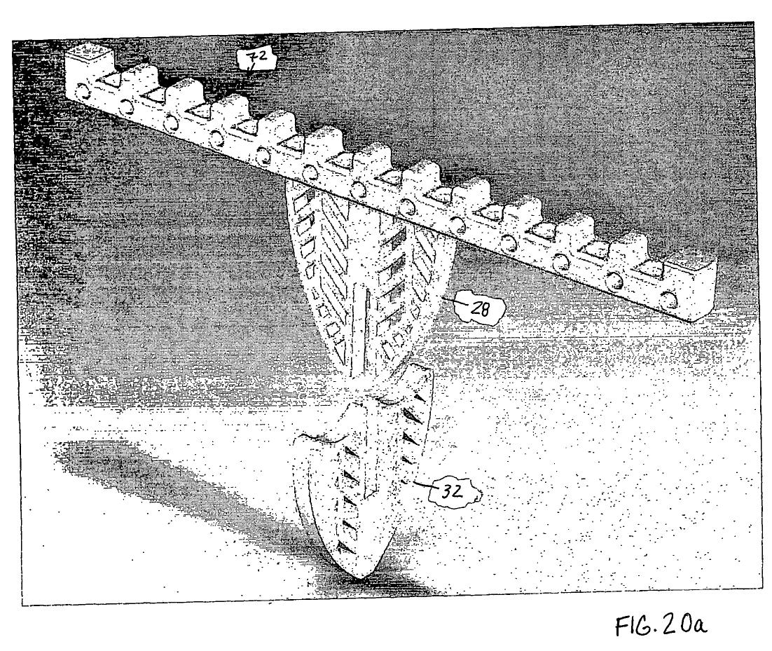

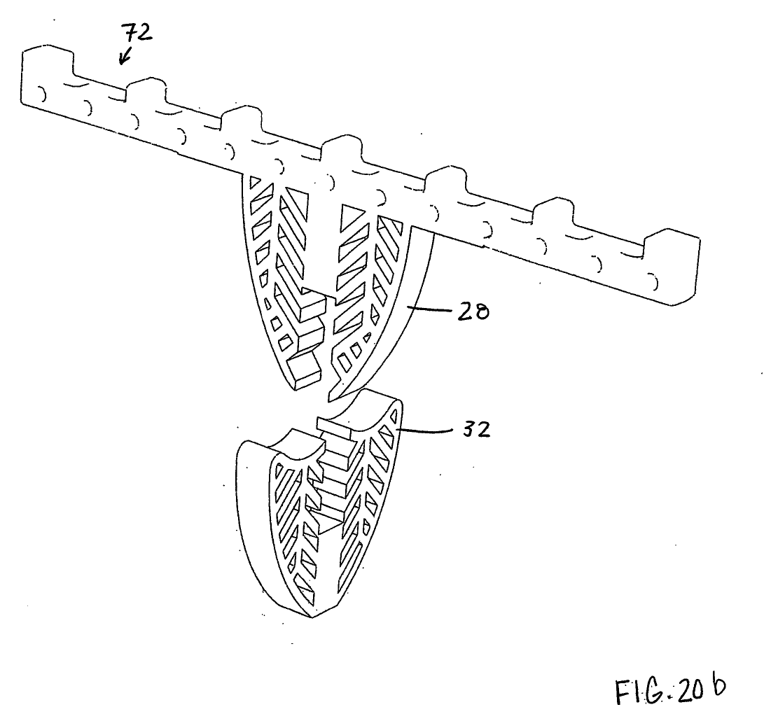

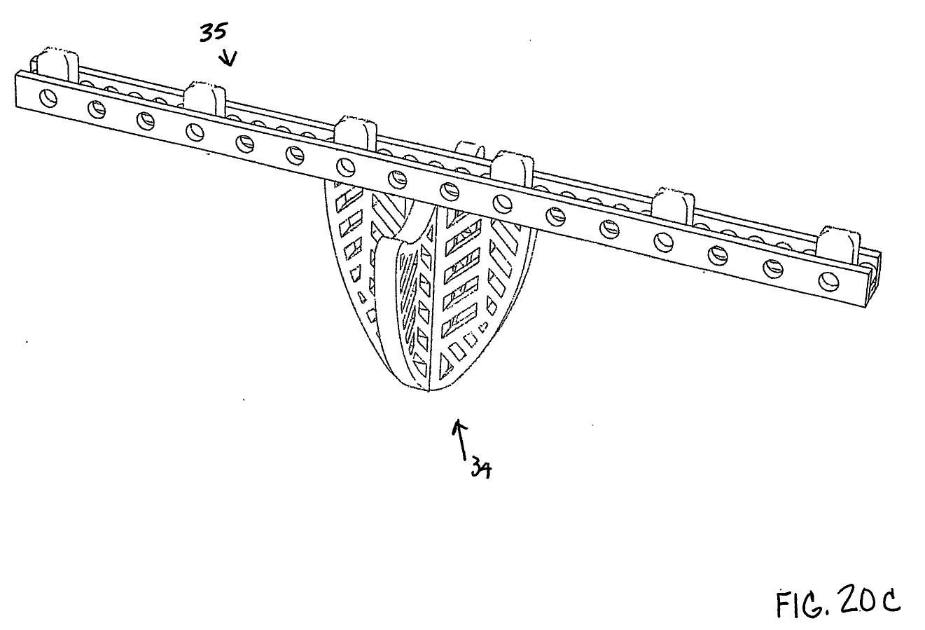

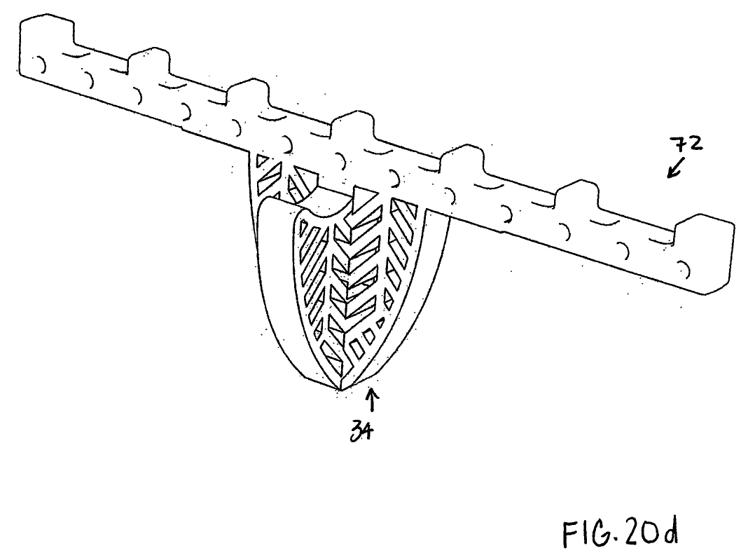

FIGS. 20 and 20a-20d show a cast bridge 72 with reinforcing structure 34. The ladder 10 and truss 20 are merged into a one piece flat plane cast bridge 72. The cast bridge 72 may be made of an appropriate material, such as, for example, gold, titanium, laboratory processed composite, etc. The cast bridge 72 is imbedded into unpolymerized composite resin, and then the resin is tamped over and light-polymerized or cured. Thus, the cast bridge 72 will form the contact points, the marginal ridges, and the occlusal stops of a bonded, composite restoration.

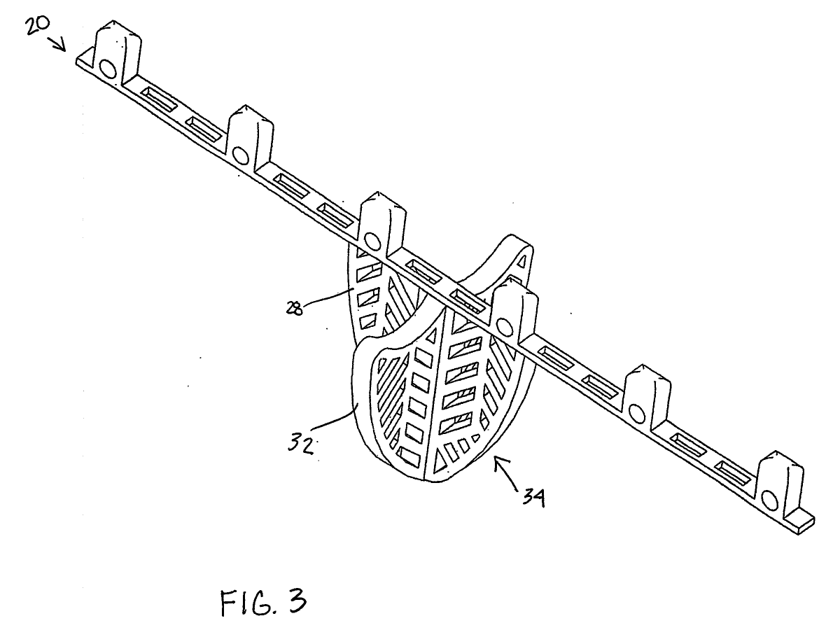

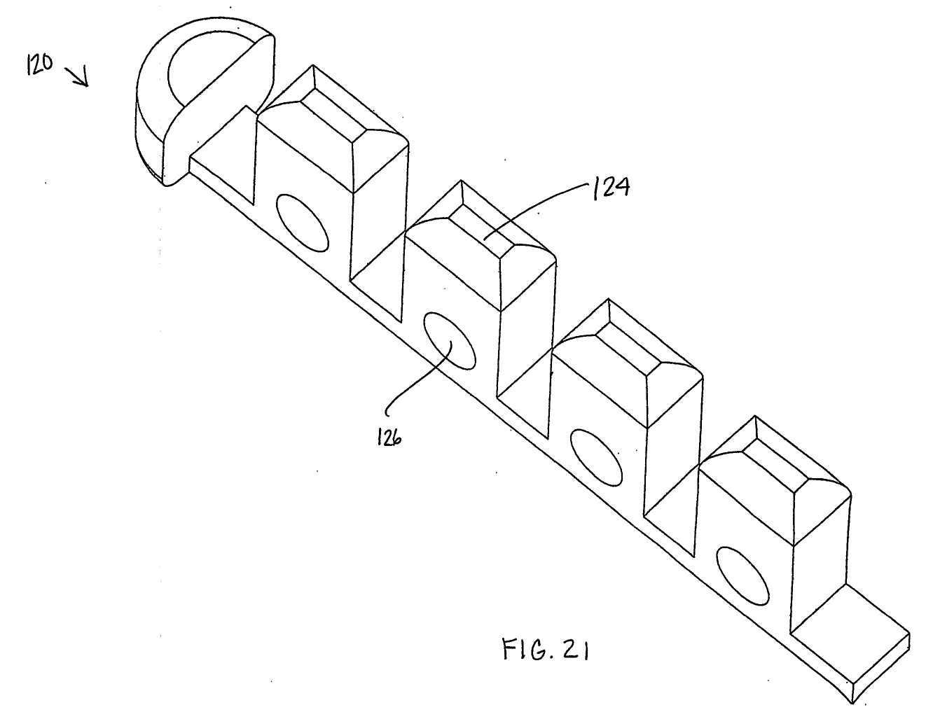

FIGS. 21-25 are an adaptation of one or more features of the present invention for use with individual single composite restorations. FIG. 21 illustrates a truss structure 120 similar to the truss structure 20 in FIGS. 1-20 for insertion into a single tooth. The truss structure 120 has a plurality of apertures 126 or perforations therethrough. The apertures 126 in the truss 120 can be round and are distributed to, for example, allow for the flow of composite resin. The truss 120 also has projections 124 to, for example, act as occlusal stops.

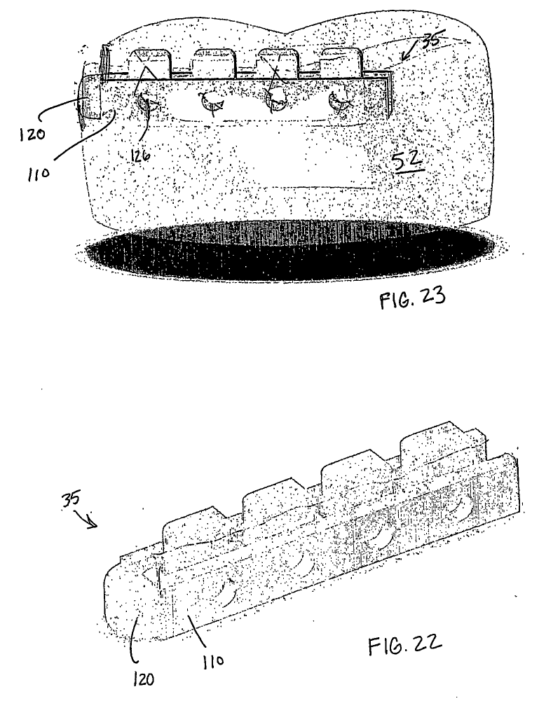

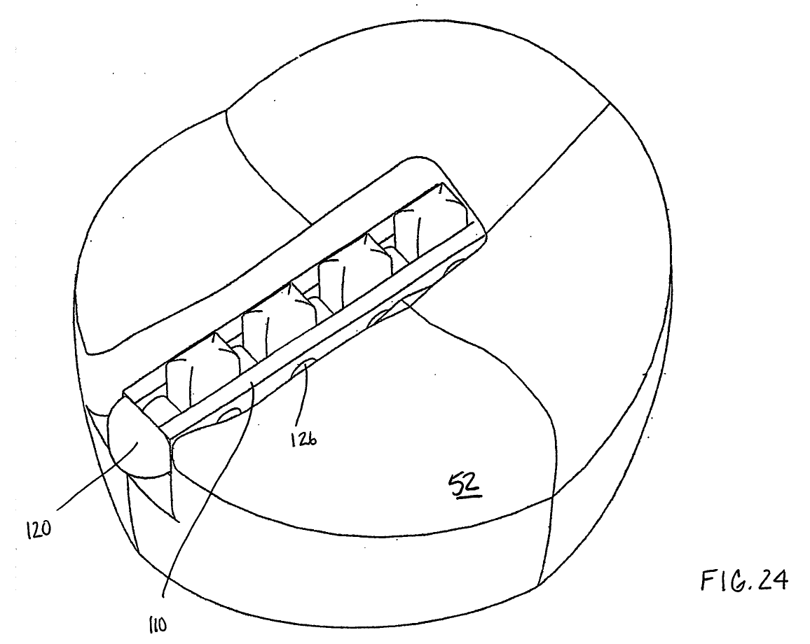

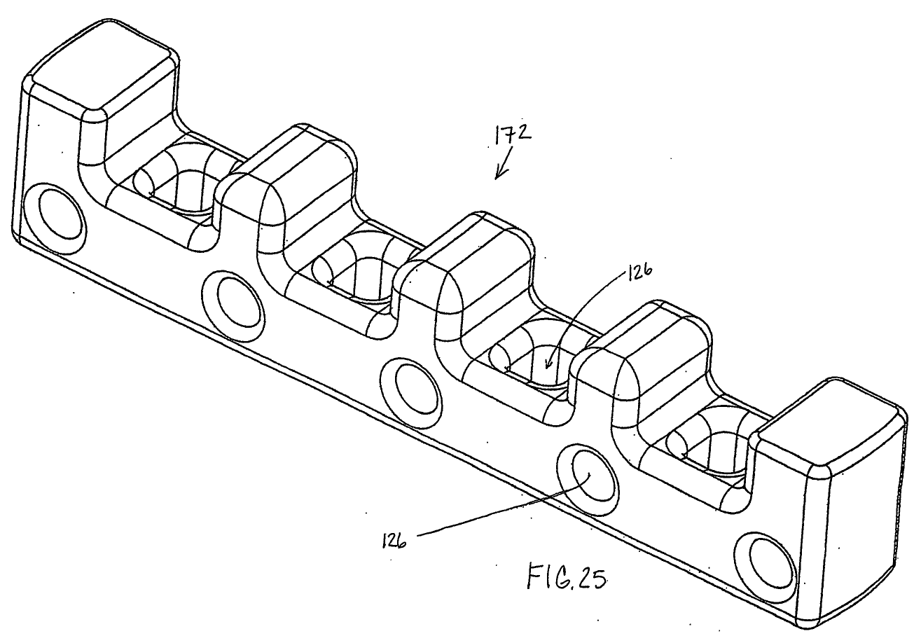

As shown in FIG. 22, the projections 124 on the truss 120 may also be used for engagement through rungs 114 of a ladder 110. The ladder 110 is similar to the ladder 10 in FIGS. 1-20. In the illustrated construction, the projections 124 of the truss 120 in FIG. 22 fit through every rung 114 of the ladder 110, which is a preferred construction for a single insert composite restoration 108. However, depending on the size of the tooth and the size of the ladder 110, the projections 124 of the truss 120 may engage the ladder 110 between every rung, every other rung, or every third rung 114. The combination of ladder 110 and truss 120 forms abridge 135, similar to the bridge 35 shown in the constructions of FIGS. 1-20. FIG. 23 shows the bridge 135 placed in into a single tooth. From an alternate view in FIG. 24, composite resin 58 will be allowed to flow around the entire system as well as into the apertures 126 of the truss 120 and ladder 110 insert as to bond with a tooth 52.

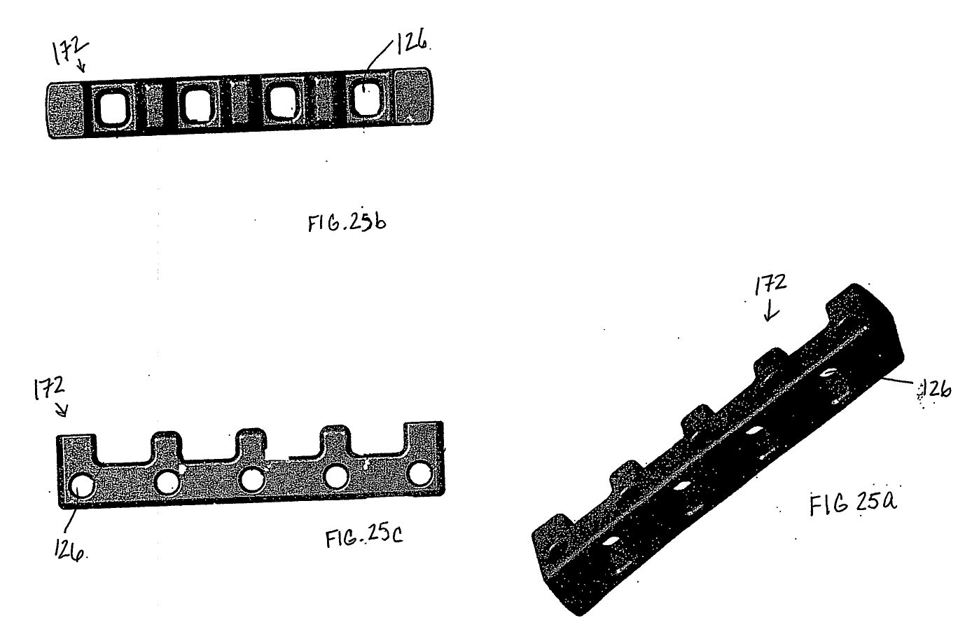

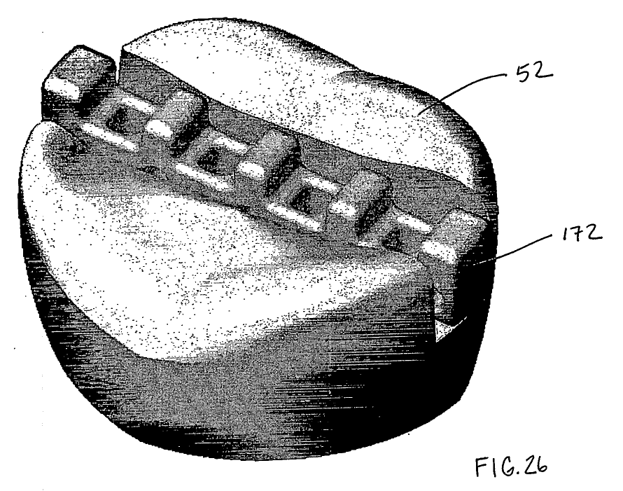

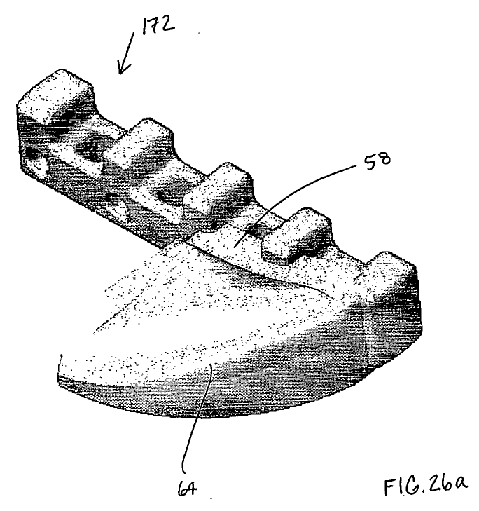

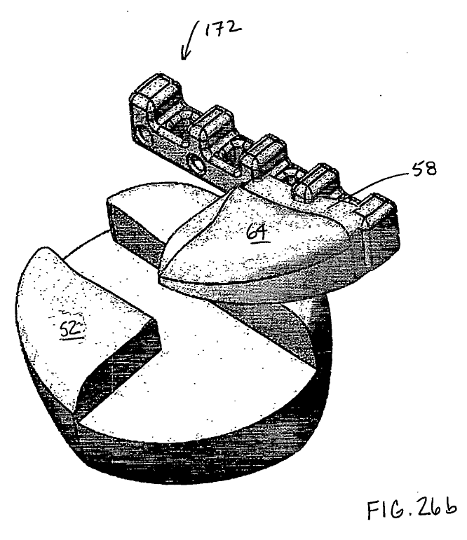

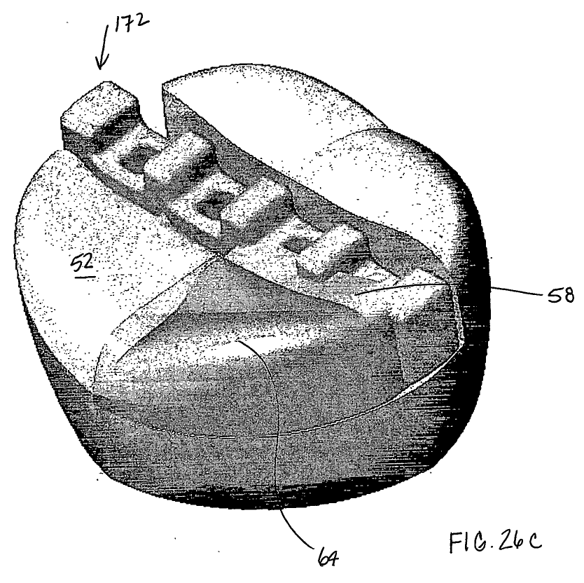

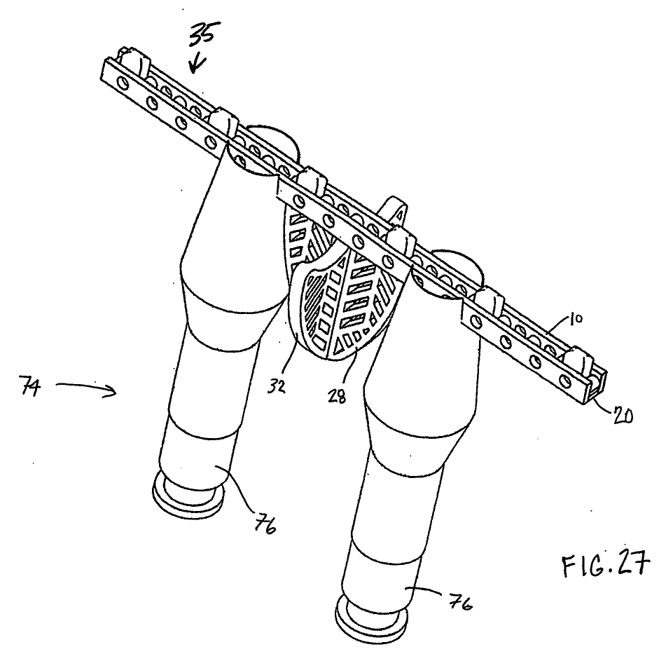

FIG. 25 illustrates a finished version of an insert 172 for use in individual single composite restorations. The ladder 110 and truss 120 are merged into the one piece flat plane cast insert 172. The insert 172 can be made of an appropriate material, such as, for example, gold, titanium, laboratory processed composite, etc. The insert 172 is imbedded into unpolymerized composite resin and then the resin is tamped over and light-polymerized or cured. Thus, the insert 172 will form the contact points, the marginal ridges, and the occlusal stops of a bonded, composite restoration. The insert 172 includes multiple apertures 126 to, for example, allow resin to flow through and around the insert 172 in creating the composite restoration. FIGS. 25a-25c are multiple views of the insert 172 to illustrate the location of the apertures 126. The location of the apertures 126 is not limited to the locations shown. More or fewer apertures 126 can be incorporated into the insert 172 at nearly any location on the insert 172. FIGS. 26a-26c illustrate the insert 172 with composite resin bonding a quarter of a pontic to the insert 172.

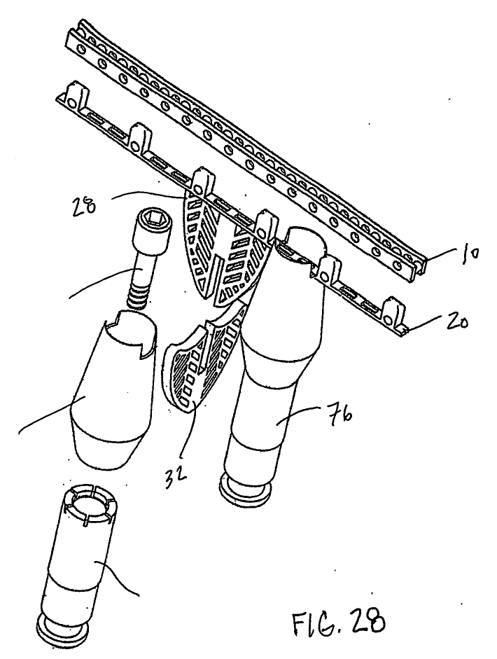

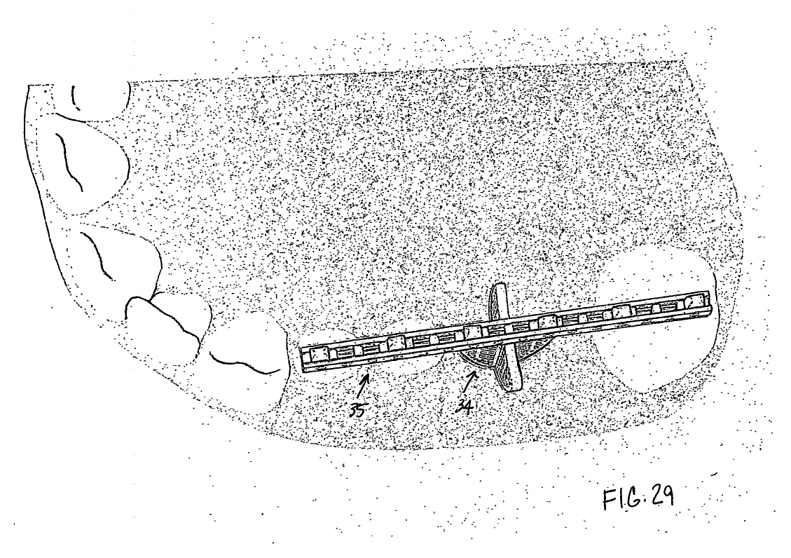

FIG. 27 and FIG. 28 illustrate the bridge 35 adapted for an implant bridge 74 with implant legs 76. The implant legs 76 are adapted to be inserted into the jaw of a patient. The implant legs 76 fit around the outside of the ladder 10 and can be secured thereto. The implant legs 76 can be positioned at a variety of different locations along the length of the ladder 10. One or more reinforcing structures 34 can inserted between the legs 76 of the implant bridge 74.

In some aspects, the present invention also generally includes a system for making and installing a temporary bridge, in which the dentist makes the temporary bridge chair side. The dentist first selects the appropriate length of the ladder 10 and snaps in a section of the truss 20 with one, two, three, or more reinforcing structures 34 depending on how many teeth are missing.

The dentist can select a reinforcement 70 that slides into the side apertures or perforations 16 in the rails 12. The fingers 66 sit lingual to the prepared teeth (e.g., molar, bicuspid, cuspid, lateral, and central), and the dentist sets a small amount of unpolymerized light-cured composite on the occlusal surface of the prepared teeth.

The dentist places the ladder 10, truss 20, and one or more reinforcing structures 34 into the unpolymerized light-cured composite. The dentist partially light-cures the resin without bonding the resin to the tooth. The dentist takes a vacuum-formed clear stent and fills it with acrylic or composite, then sets it over the ladder 10 and truss 20 on the prepared teeth, so that when the temporary bridge is removed, the ladder 10, truss 20, and pontic(s) are picked up because they are internally incorporated in the temporary bridge. The projections 24 on the truss 20 act as occlusal stops to prevent the wearing of the bridge. The temporary bridge is both reinforced and slow to wear occlusally to provide a long-term temporary bridge.

In contrast, in conventional dental bridges, the laboratory fashions the temporary bridge in a different manner. After receiving the study models and bite from the dentist, the laboratory prepares the designated teeth for crown preps. The laboratory selects the appropriate length and pontic size for the bridge and appropriate lingual reinforcement systems. The laboratory constructs the metal reinforced temporary bridge for placement by the dentist into the patient's mouth.

In some aspects, the system of the present invention eliminates any casting to be done because the individual components (e.g., the ladder 10, truss 20, substructure 28, etc.) can be a part of an extensive kit available to the dentist. For the reinforced single, double, or more pontic bridge, all the dentist, has to do is send the laboratory a set of unprepared study models, a bite, and a shade. The laboratory can groove the MO, DO, MOD preps in the adjacent teeth and fabricate a trim coping for the dentist to follow. The laboratory can then fabricate the bridge. When the dentist receives the bridge, the dentist only needs to put the trim coping in the patient's mouth, groove the teeth, apply the bonding resin, put the composite into the grooves, press the ladder 10 and truss 20 into the composite, tamp it over, light-cure the ladder 10 and truss 20 into the composite, and finally adjust the occlusion.

The ladder 10 and truss 20 of the present invention can be used in a variety of different applications. In one exemplary application, the ladder 10 and truss 20 can be used to stabilize mobile teeth up to and including an entire arch using just the ladder 10, or the ladder 10 in combination with the truss 20 or the truss 20 with the substructure 26 for anchoring the pontic. This is accomplished by embedding the ladder 10 and truss 20 into MO, DO, or MOD preparations in the teeth to be stabilized, in which unpolymerized composite resin has been placed. After seating the ladder 10 and truss 20, the resin oozes through the apertures or perforations 16 in the ladder 10 and the apertures 26 in the truss 20. After the resin is sufficiently set, it is tamped down and molded. The composite resin is then light cured or polymerized to create a permanent reinforced bridge.

As shown in FIG. 17, in an exemplary application in which two bicuspids are missing, the bridge 35 could be fabricated by splinting three molars together in the posterior. In another situation in which two anterior teeth are missing, two, three, or more teeth in the anterior (e.g., cuspid, lateral, etc.) could be splinted around the anterior arch if necessary. For the anterior portion of the mouth, if a tooth is missing, an anterior pontic could be fabricated out of composite and attached to the metal shield 42 with metal projections 44.

In another exemplary application, the interlocking ladder 10 and truss 20 with substructure(s) 28 and pontic(s) can be used to replace a missing tooth or teeth at any location over the arch. An artificial tooth or teeth can be formed around the metal substructure 28 by the dentist chair-side either free-hand or with celluloid pontic halves made from composite resin (light-cured or light-polymerized). The artificial tooth or teeth can also be fabricated in a dental laboratory by a dental laboratory technician. The resulting bridge is then bonded in two or more teeth after preparation of those teeth by the dentist and inserting the ladder 10 and truss 20 as previously discussed.

In yet another exemplary application, the interlocking ladder 10 and truss 20 with or without metal substructure(s) or pontic(s) may be used by a dentist or laboratory technician to construct a metal reinforced temporary bridge with metal occlusal stops, eliminating the conventional use of custom metal castings. The ladder 10 and truss 20 with or without metal substructure(s) 28 or pontic(s) are incorporated chair-side by the dentist using acrylic or composite resin in conjunction with a vacuum-formed clear celluloid bridge form, or by the laboratory using heat processed acrylic.

In another exemplary application, the ladder 10 and truss 20 as designed without the metal substructure(s) 28 or pontic(s) can also be cast as one piece. The castings can be made from an appropriate material, such as, for example, titanium, dental hard-gold alloy, crown and bridge non-precious metal, stainless steel, cast ceramic such as Empress, among other materials. The castings can fit within an MO, DO, or MOD restoration to act as a reinforcement, contact point or former, occlusal and marginal ridge stops for the MO, DO, or MOD light-cured composite restoration into which they are embedded to enhance the strength, longevity and durability of a light-cured or light-polymerized resin restoration. The castings can also be used to reinforce a single temporary crown as previously discussed. The ladder 10 and truss 20 can provide a long lasting temporary crown, which is substantially resistant to occlusal wear.

In yet another exemplary application, the ladder 10 and truss 20, with or without metal substructure(s) or pontic(s), may also be used by a laboratory to fabricate an all-composite (such as BELLE GLASS) permanent bridges. After the dentist supplies an impression of conventionally prepared teeth, the laboratory can incorporate the ladder 10 and truss 20 with pontic(s) into a composite bridge to reinforce spans of missing teeth. Such structure can substantially resist torquing and provide occlusal stops and mesial and distal marginal ridge stops. Additionally, all of the previously-discussed applications may all be accomplished at the same time in the same arch.

What is claimed is:

1. A dental bridge comprising:
a first member extending along an axis and connectable to at least one tooth; and
a second member separate from the first member, the second member being connectable to the first member in an orientation in which the second member has a longitudinal portion which extends parallel to the axis.

2. The dental bridge of claim 1, wherein the first member includes a ladder structure, the ladder structure including opposing rails connected by a plurality of rungs, adjacent ones of the plurality of rungs defining an opening therebetween.

3. The dental bridge of claim 2, wherein at least one of the rails includes a rail wall, the rail wall defining wall openings therethrough.

4. The dental bridge of claim 3, wherein each of the rails includes a rail wall, each rail wall defining wall openings therethrough.

5. The dental bridge of claim 3, wherein each of the wall openings communicate with at least an associated opening.

6. The dental bridge of claim 1, wherein the second member includes a truss member.

7. The dental bridge of claim 6, wherein the truss member includes a first truss member providing the longitudinal portion and a second truss member depending from the first truss member, the second truss member extending in a plane parallel to the axis.

8. The dental bridge of claim 7, wherein the second truss member is integrally connected to the first truss member.

9. The dental bridge of claim 7, wherein the truss member includes a third truss member depending from the first truss member, the third truss member extending in a plane transverse to the axis and transverse to the plane of the second truss member.

10. The dental bridge of claim 9, wherein the third truss member is separate from and connectable to at least one of the first truss member and the second truss member.

11. The dental bridge of claim 1, wherein the first member includes a ladder structure, the ladder structure including opposing rails connected by a plurality of rungs, adjacent ones of the plurality of rungs defining an opening therebetween, and wherein the second member includes a plurality of projections, each of the plurality of projections being engageable in an associated opening.

12. The dental bridge of claim 11, wherein the first member has an upper surface, and wherein at least one of the plurality of projections extends above the upper surface of the first member.

13. The dental bridge of claim 12, wherein each of the plurality of projections extends above the upper surface of the first member.

14. The dental bridge of claim 11, wherein the second member includes a truss member, the truss member including a first truss member providing the longitudinal portion and supporting the plurality of projections, the truss member further including a second truss member depending from the first truss member, the second truss member extending in a plane parallel to the axis.

15. The dental bridge of claim 1, wherein the first member has a first end and a second end spaced along the axis, and wherein the dental bridge further comprises:
a third member separate from and connectable to one of the first end and the second end of the first member; and
a connecting assembly operable to connect the third member to the first member.

16. The dental bridge of claim 15, wherein the third member includes a wire attachment for anterior teeth.

17. The dental bridge of claim 15, wherein the third member includes a perforated band attachment for anterior teeth.

18. The dental bridge of claim 15, wherein the connecting assembly includes a first connecting portion provided by the first member and a second connecting portion provided by the third member.

19. The dental bridge of claim 18, wherein the first member includes a ladder structure, the ladder structure including opposing rails connected by a plurality of rungs, wherein the first connecting portion includes at least one of the plurality of rungs.

20. The dental bridge of claim 19, wherein the second connecting portion defines a first recess for receiving one of the plurality of rungs, the first recess extending in a direction transverse to the axis, the second connecting portion defining a second recess for receiving another of the plurality of rungs, the second recess extending in a direction along the axis.

21. The dental bridge of claim 1, further comprising a support member connectable to at least one of the first member and the second member, the support member being engageable with an outer surface of a tooth.

22. The dental bridge of claim 21, wherein the support member includes lingual finger reinforcement.

23. A dental bridge comprising:
a ladder structure extending along an axis and connectable to at least one tooth, the ladder structure including opposing rails connected by a plurality of rungs, adjacent ones of the plurality of rungs defining an opening therebetween; and
a truss member separate and connectable to the ladder structure, the truss member including a first truss member extending parallel to the axis and a second truss member depending from the first truss member, the second truss member extending in a plane parallel to the axis.

24. The dental bridge of claim 23, wherein each of the rails includes a rail wall, each rail wall defining wall openings therethrough.

25. The dental bridge of claim 24, wherein each of the wall openings communicate with at least an associated opening.

26. The dental bridge of claim 23, wherein the second truss member is integrally connected to the first truss member.

27. The dental bridge of claim 23, wherein the truss member includes a third truss member depending from the first truss member, the third truss member extending in a plane transverse to the axis and transverse to the plane of the second truss member.

28. The dental bridge of claim 27, wherein the third truss member is separate from and connectable to at least one of the first truss member and the second truss member.

29. The dental bridge of claim 23, wherein the truss member includes a plurality of projections, each of the plurality of projections being engageable in an opening.

30. The dental bridge of claim 29, wherein the ladder structure has an upper surface, and wherein at least one of the plurality of projections extends above the upper surface of the ladder structure.

31. The dental bridge of claim 30, wherein each of the plurality of projections extends above the upper surface of the ladder structure.

32. The dental bridge of claim 29, wherein the first truss member supports the plurality of projections.

33. The dental bridge of claim 23, wherein the ladder structure has a first end and a second end spaced along the axis, and wherein the dental bridge further comprises:
a third member separate from and connectable to one of the first end and the second end of the ladder structure; and
a connecting assembly operable to connect the third member to the ladder structure.

34. The dental bridge of claim 33, wherein the third member includes a wire attachment for anterior teeth.

35. The dental bridge of claim 33, wherein the third member includes a perforated band attachment for anterior teeth.

36. The dental bridge of claim 33, wherein the connecting assembly includes a first connecting portion provided by the ladder structure and a second connecting portion provided by the third member.

37. The dental bridge of claim 36, wherein the first connecting portion includes at least one of the plurality of rungs.

38. The dental bridge of claim 37, wherein the second connecting portion defines a first recess for receiving one of the plurality of rungs, the first recess extending in a direction transverse to the axis, the second connecting portion defining a second recess for receiving another of the plurality of rungs, the second recess extending in a direction along the axis.

39. The dental bridge of claim 23, further comprising a support member connectable to at least one of the ladder structure and the truss member, the support member being engageable with an outer surface of a tooth.

40. The dental bridge of claim 39, wherein the support member includes lingual finger reinforcement.

41. A method of assembling a dental bridge, the dental bridge including a ladder structure extending along an axis and connectable to at least one tooth, the ladder structure including opposing rails connected by a plurality of rungs, adjacent ones of the plurality of rungs defining an opening therebetween, the dental bridge also including a truss member separate and connectable to the ladder structure, the truss member including a first truss member extending parallel to the axis and a second truss member depending from the first truss member, the second truss member extending in a plane parallel to the axis, the method comprising the acts of:
supporting a pontic on the truss member;
connecting the ladder structure and the truss member;
forming a groove in a tooth;
applying a bonding resin;
placing composite in the groove; and
supporting at least a portion of the ladder structure in the composite in the groove.
